(19) United States
(12) Patent Application Publication
(10) Pub. No.: US 2025/0343378 A1
(43) Pub. Date: Nov. 6, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: Ying-Chung CHEN, New Taipei City (TW); Mu-Jung HUANG, New Taipei City (TW)

(21) Appl. No.: 19/199,282

(22) Filed: May 5, 2025

(30) Foreign Application Priority Data
May 6, 2024 (TW) 113204570

(51) Int. Cl. H01R 13/6586; H01R 13/502

(52) U.S. Cl. CPC H01R 13/6586; H01R 13/502

(57) ABSTRACT

An electrical connector, comprising a non-grounding conductive terminal, a grounding conductive terminal, a conductive plastic base, and an insulating core base, wherein the conductive plastic base is electrically connected to the grounding conductive terminal to transmit a shielding signal such as a grounding signal, the grounding conductive terminal comprises a first grounding terminal pin, a second grounding terminal pin, and a grounding terminal pin bridging structure, the grounding terminal pin bridging structure bridges across the non-grounding terminal pin and electrically connects the first major grounding terminal pin and the second major grounding terminal pin, and the insulating core base positions the first grounding terminal pin and the second grounding terminal pin at both sides of the non-grounding terminal pin to provide an electrically shielding environment for signal transmission of the non-grounding conductive terminal, so as to meet the special needs and development of electronic devices.

### CROSS-REFERENCE TO RELATED APPLICATIONS

This application claims the priority of Republic of China Patent Application No. 113204570 filed on May 6, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector capable of reducing the degree of interference during high-speed signal transmission.

### Descriptions of the Related Art

In recent years, electrical connectors have been widely applied to various electronic devices, where multiple conductive terminals on the electrical connector are used to transmit signals. However, with the evolving demands and development of electronic devices, these multiple conductive terminals may be required to transmit high-speed signals. Currently, electrical connectors are prone to interference during high-speed signal transmission (such interference may include electromagnetic interference from the external environment or crosstalk interference caused by coupling between the multiple conductive terminals of the electrical connector), which leads to signal attenuation.

Therefore, how to solve the issue of interference during high-speed signal transmission in electrical connectors is a problem urgently to be addressed by those skilled in the art.

### SUMMARY OF THE INVENTION

In view of the drawbacks of the prior art mentioned above, the present application provides an electrical connector, one side of which is an electrical connector major side, wherein the electrical connector comprises: a major conductive terminal set comprising a major non-grounding conductive terminal and a major grounding conductive terminal, wherein the major non-grounding conductive terminal comprises a major non-grounding terminal pin, and the major grounding conductive terminal comprises a first major grounding terminal pin, a second major grounding terminal pin and a major grounding terminal pin bridging structure, wherein the major grounding terminal pin bridging structure is configured to be a bridge over the major non-grounding terminal pin to connect the first major grounding terminal pin and the second major grounding terminal pin, such that the major grounding terminal pin bridging structure, the first major grounding terminal pin, and the second major grounding terminal pin are electrically connected; a major conductive plastic base comprising a major conductive plastic base grounding terminal mating structure and a major conductive plastic base non-grounding terminal divider structure, wherein the major conductive plastic base grounding terminal mating structure is mated with the major grounding conductive terminal such that the major conductive plastic base and the major grounding conductive terminal are electrically connected to each other to form a major grounding conductive terminal module, and the major conductive plastic base non-grounding terminal divider structure is configured to divide the major conductive plastic base from the major non-grounding conductive terminal so as to prevent electrical connection between the major non-grounding conductive terminal and the major grounding conductive terminal module; and a major insulating core base comprising a major insulating core base non-grounding terminal mating structure and a major insulating core base grounding terminal module mating structure, wherein the major insulating core base non-grounding terminal mating structure is mated with the major non-grounding conductive terminal, and the major insulating core base grounding terminal module mating structure is mated with the major grounding conductive terminal module, so as to allow the major insulating core base, the major non-grounding conductive terminal and the major grounding conductive terminal module to form a major electrical connector subcomponent located on the electrical connector major side, wherein, in the major electrical connector subcomponent, the first major grounding terminal pin and the second major grounding terminal pin are disposed on opposite sides of the major non-grounding terminal pin to provide shielding for the major non-grounding terminal pin.

Preferably, the electrical connector said above, wherein the major insulating core base further comprises a major insulating core terminal pin support structure, wherein the major non-grounding terminal pin, the first major grounding terminal pin and the second major grounding terminal pin are respectively abutted against the major insulating core terminal pin support structure, such that the major insulating core terminal pin support structure provides structural support for the major non-grounding terminal pin, the first major grounding terminal pin and the second major grounding terminal pin.

Preferably, the electrical connector said above, wherein the major grounding terminal pin bridging structure comprises a major grounding terminal pin bridging shielding structure, and the major grounding terminal pin bridging shielding structure is extended beyond the major non-grounding terminal pin to provide shielding for the major non-grounding terminal pin.

Preferably, the electrical connector said above, wherein the major conductive plastic base grounding terminal mating structure comprises a first major conductive plastic base grounding pin mating substructure and a second major conductive plastic base grounding pin mating substructure, and the first major conductive plastic base grounding pin mating substructure and the second major conductive plastic base grounding pin mating substructure are respectively mated with the first major grounding terminal pin and the second major grounding terminal pin.

Preferably, the electrical connector said above, wherein the first major conductive plastic base grounding pin mating substructure and the second major conductive plastic base grounding pin mating substructure are clamp arm mating structures configured to respectively clamp the first major grounding terminal pin and the second major grounding terminal pin.

Preferably, the electrical connector said above, wherein the major conductive plastic base non-grounding terminal divider structure comprises a major divider structure separating space, and the major divider structure separating space is configured to separate the major conductive plastic base from the major non-grounding conductive terminal.

Preferably, the electrical connector said above, wherein another side of the electrical connector is an electrical connector minor side, and the electrical connector further comprises: a minor conductive terminal set comprising a minor non-grounding conductive terminal and a minor grounding conductive terminal, wherein the minor non-grounding conductive terminal comprises a minor non-grounding terminal pin, and the minor grounding conductive terminal comprises a first minor grounding terminal pin, a second minor grounding terminal pin and a minor grounding terminal pin bridging structure, wherein the minor grounding terminal pin bridging structure is configured to be a bridge over the minor non-grounding terminal pin to connect the first minor grounding terminal pin and the second minor grounding terminal pin, such that the minor grounding terminal pin bridging structure, the first minor grounding terminal pin and the second minor grounding terminal pin are electrically connected. a minor conductive plastic base comprising a minor conductive plastic base grounding terminal mating structure and a minor conductive plastic base non-grounding terminal divider structure, wherein the minor conductive plastic base grounding terminal mating structure is mated with the minor grounding conductive terminal such that the minor conductive plastic base and the minor grounding conductive terminal are electrically connected to each other to form a minor grounding conductive terminal module, and the minor conductive plastic base non-grounding terminal divider structure is configured to divide the minor conductive plastic base from the minor non-grounding conductive terminal so as to prevent electrical connection between the minor non-grounding conductive terminal and the minor grounding conductive terminal module; and a minor insulating core base comprising a minor insulating core base non-grounding terminal mating structure and a minor insulating core base grounding terminal module mating structure, wherein the minor insulating core base non-grounding terminal mating structure is mated with the minor non-grounding conductive terminal, and the minor insulating core base grounding terminal module mating structure is mated with the minor grounding conductive terminal module, so as to allow the minor insulating core base, the minor non-grounding conductive terminal and the minor grounding conductive terminal module to form a minor electrical connector subcomponent located on the electrical connector minor side, wherein, in the minor electrical connector subcomponent, the first minor grounding terminal pin and the second minor grounding terminal pin are disposed on opposite sides of the minor non-grounding terminal pin to provide shielding for the minor non-grounding terminal pin.

Preferably, the electrical connector said above, wherein the minor insulating core base further comprises a minor insulating core terminal pin support structure, wherein the minor non-grounding terminal pin, the first minor grounding terminal pin and the second minor grounding terminal pin are respectively abutted against the minor insulating core terminal pin support structure, such that the minor insulating core terminal pin support structure provides structural support for the minor non-grounding terminal pin, the first minor grounding terminal pin and the second minor grounding terminal pin.

Preferably, the electrical connector said above, wherein the minor grounding terminal pin bridging structure comprises a minor grounding terminal pin bridging shielding structure, and the minor grounding terminal pin bridging shielding structure is extended beyond the minor non-grounding terminal pin to provide shielding for the minor non-grounding terminal pin.

Preferably, the electrical connector said above, wherein the minor grounding terminal pin bridging structure comprises a minor grounding terminal pin bridging shielding structure, the minor grounding terminal pin bridging shielding structure extending in front of the minor non-grounding terminal pin so as to provide shielding in front of the minor non-grounding terminal pin.

Preferably, the electrical connector said above, wherein the minor conductive plastic base grounding terminal mating structure comprises a first minor conductive plastic base grounding pin mating substructure and a second minor conductive plastic base grounding pin mating substructure, wherein the first minor conductive plastic base grounding pin mating substructure is mated with the first minor grounding terminal pin, and the second minor conductive plastic base grounding pin mating substructure is mated with the second minor grounding terminal pin.

Preferably, the electrical connector said above, wherein the first minor conductive plastic base grounding pin mating substructure is clamp arm mating structure configured to clamp the first minor grounding terminal pin, and the second minor conductive plastic base grounding pin mating substructure is clamp arm mating structure configured to clamp the second minor grounding terminal pin.

Preferably, the electrical connector said above, wherein the minor conductive plastic base non-grounding terminal divider structure comprises a minor divider structure separating space, and the minor divider structure separating space is configured to separate the minor conductive plastic base from the minor non-grounding conductive terminal.

Preferably, the electrical connector said above, wherein the major conductive plastic base further comprises a major conductive plastic base connecting structure and a major insulating core base exposure structure, and the minor conductive plastic base further comprises a minor conductive plastic base connecting structure and a minor insulating core base exposure structure, wherein the major insulating core base exposure structure exposes the major conductive plastic base connecting structure, and the minor insulating core base exposure structure exposes the minor conductive plastic base connecting structure, such that the major conductive plastic base connecting structure is connected to the major conductive plastic base connecting structure, and the minor conductive plastic base connecting structure is connected to the minor conductive plastic base connecting structure, so as to electrically connect the major conductive plastic base and the minor conductive plastic base to provide shielding between the major non-grounding terminal pin and the minor non-grounding terminal pin.

Preferably, the electrical connector said above, further comprising a conductive metal layer, the conductive metal layer comprising a major conductive metal layer mating structure and a minor conductive metal layer mating structure, wherein the major conductive metal layer mating structure is mated with the major insulating core base, and the minor conductive metal layer mating structure is mated with the minor insulating core base, such that the conductive metal layer is disposed between the major electrical connector subcomponent and the minor electrical connector subcomponent.

Preferably, the electrical connector said above, wherein the major conductive metal layer mating structure and the minor conductive metal layer mating structure are inserting structures.

Preferably, the electrical connector said above, wherein the conductive metal layer further comprises a major conductive metal layer connecting structure and a minor conductive metal layer connecting structure, the major conductive plastic base further comprises a major conductive plastic base connecting structure, the minor conductive plastic base further comprises a minor conductive plastic base connecting structure, the major insulating core base further comprises a major insulating core base exposure structure, and the minor insulating core base further comprises a minor insulating core base exposure structure, wherein the major insulating core base exposure structure exposes the major conductive plastic base connecting structure, and the minor insulating core base exposure structure exposes the minor conductive plastic base connecting structure, such that the major conductive plastic base connecting structure is connected to the major conductive metal layer connecting structure, and the minor conductive plastic base connecting structure is connected to the minor conductive metal layer connecting structure, so as to electrically connect the major conductive plastic base, the minor conductive plastic base and the conductive metal layer to provide shielding between the major non-grounding terminal pin and the minor non-grounding terminal pin.

Preferably, the electrical connector said above, wherein the major conductive plastic base connecting structure and the major conductive metal layer connecting structure are complementary protrusion and recess structures, and the major conductive plastic base connecting structure and the minor conductive metal layer connecting structure are complementary protrusion and recess structures.

Preferably, the electrical connector said above, further comprising an insulating assembled core configured to be assembled with the major electrical connector subcomponent and the minor electrical connector subcomponent to respectively position the major electrical connector subcomponent and the minor electrical connector subcomponent, so as to allow the major electrical connector subcomponent and the minor electrical connector subcomponent to be assembled to form an electrical connector assembly.

Compared with the prior art, the electrical connector of the present application comprises a non-grounding conductive terminal, a grounding conductive terminal, a conductive plastic base, and an insulating core base. The conductive plastic base is electrically connected to the grounding conductive terminal for transmitting shielding signals such as grounding signals. The grounding conductive terminal comprises a first grounding terminal pin, a second grounding terminal pin, and a grounding terminal pin bridging structure. The grounding terminal pin bridging structure electrically bridges the first major grounding terminal pin and the second major grounding terminal pin while dividing the non-grounding terminal pin, such that the first grounding terminal pin and the second grounding terminal pin are located on both sides of the non-grounding terminal pin. The insulating core base positions the first grounding terminal pin and the second grounding terminal pin on both sides of the non-grounding terminal pin, thereby allowing the first grounding terminal pin and the second grounding terminal pin to provide an electrical shielding environment for signal transmission of the non-grounding conductive terminal. This configuration effectively reduces interference to the electrical connector during high-speed signal transmission, thereby optimizing the transmission quality of high-speed signals and satisfying the specific requirements and development of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the electrical connector of the present application from a first perspective in one embodiment.

FIG. 2 is a perspective schematic view of the electrical connector of the present application from a second perspective in one embodiment.

FIG. 3 is a top schematic view of the electrical connector of the present application in one embodiment.

FIG. 4 is a sectional schematic view of a partial component of the electrical connector shown in FIG. 3 cut along the line AA.

FIG. 5 is a sectional schematic view of a partial component of the electrical connector shown in FIG. 3 cut along the line BB.

FIG. 6 is a sectional schematic view of a partial component of the electrical connector shown in FIG. 3 cut along the line CC.

FIG. 7 is a sectional schematic view of a partial component of the electrical connector shown in FIG. 3 cut along the line DD.

FIG. 8 is a perspective schematic view of a partial component of the electrical connector of the present application from a first perspective in one embodiment.

FIG. 9 is a perspective schematic view of a partial component of the electrical connector of the present application from a second perspective in one embodiment.

FIG. 10 is a perspective schematic view of a partial component of the electrical connector of the present application from a first perspective in one embodiment.

FIG. 11 is a perspective schematic view of a partial component of the electrical connector of the present application from a second perspective in one embodiment.

FIG. 12 is a perspective schematic view of a partial component of the electrical connector of the present application from a first perspective in one embodiment.

FIG. 13 is a perspective schematic view of a partial component of the electrical connector of the present application from a second perspective in one embodiment.

FIG. 14 is a front schematic view of a partial component of the electrical connector of the present application from a second perspective in one embodiment.

FIG. 15 is a sectional schematic view of a partial component of the electrical connector shown in FIG. 14 cut along the line EE.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

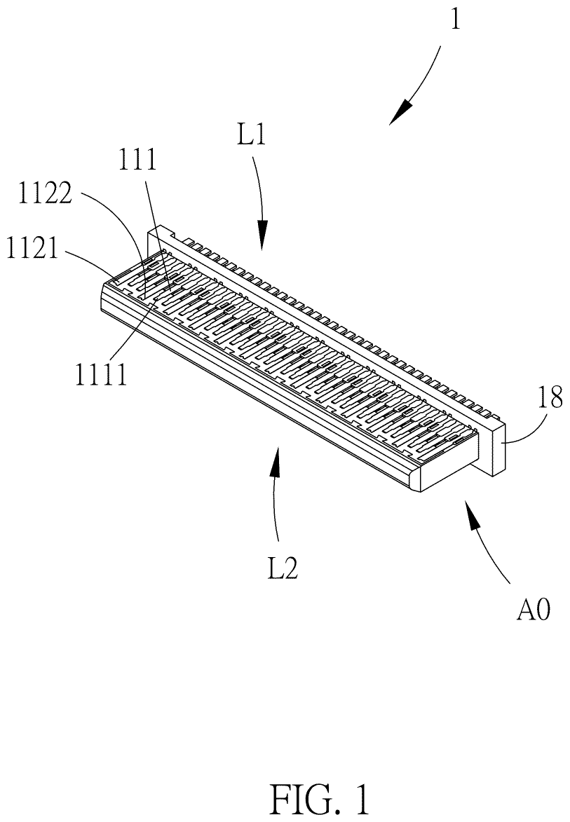

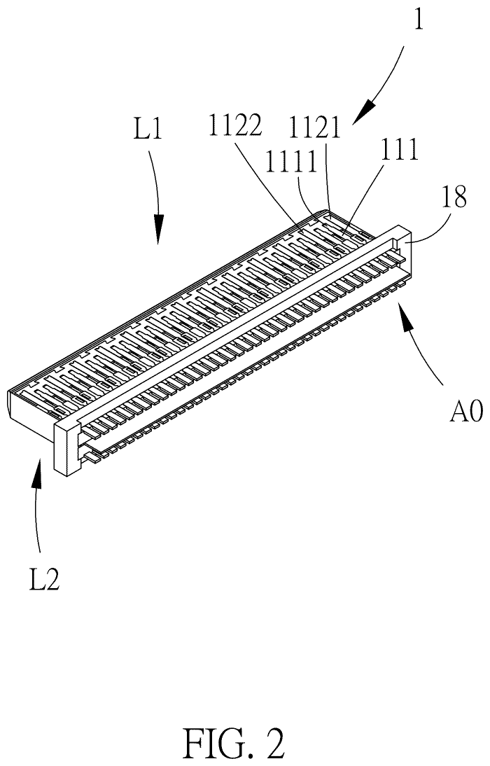

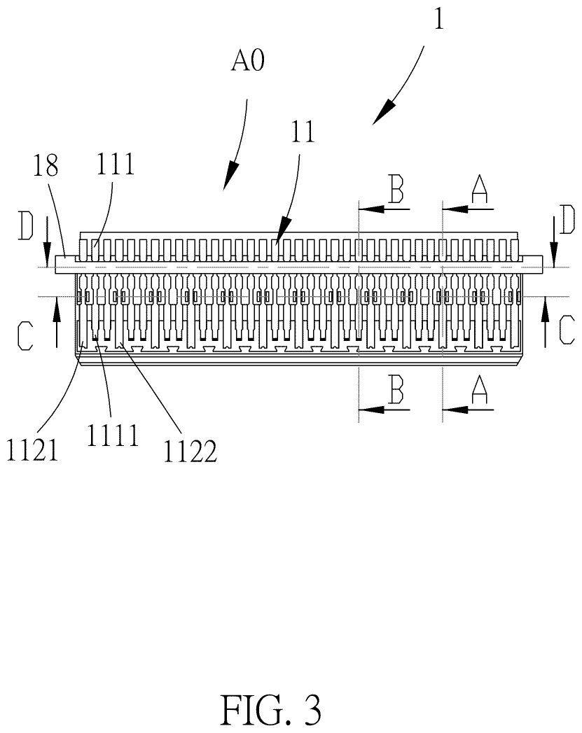

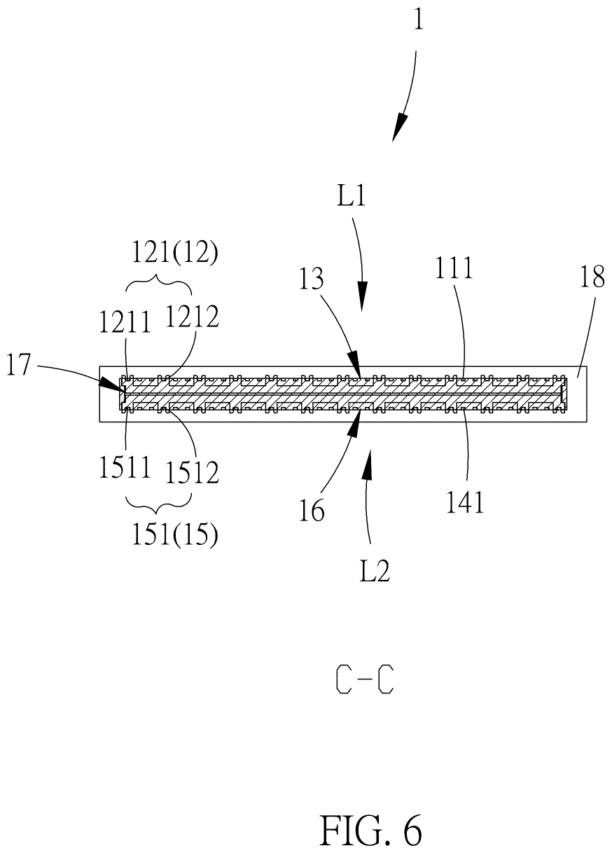

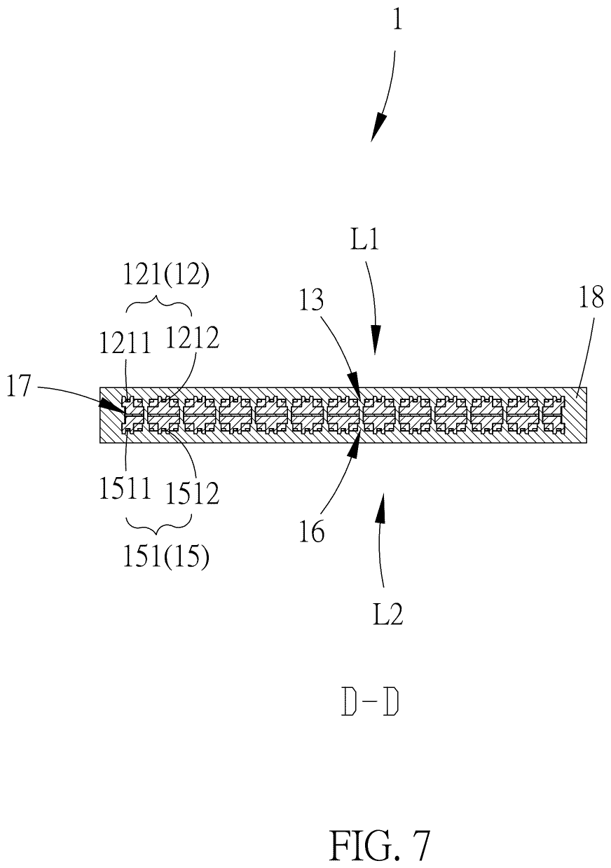

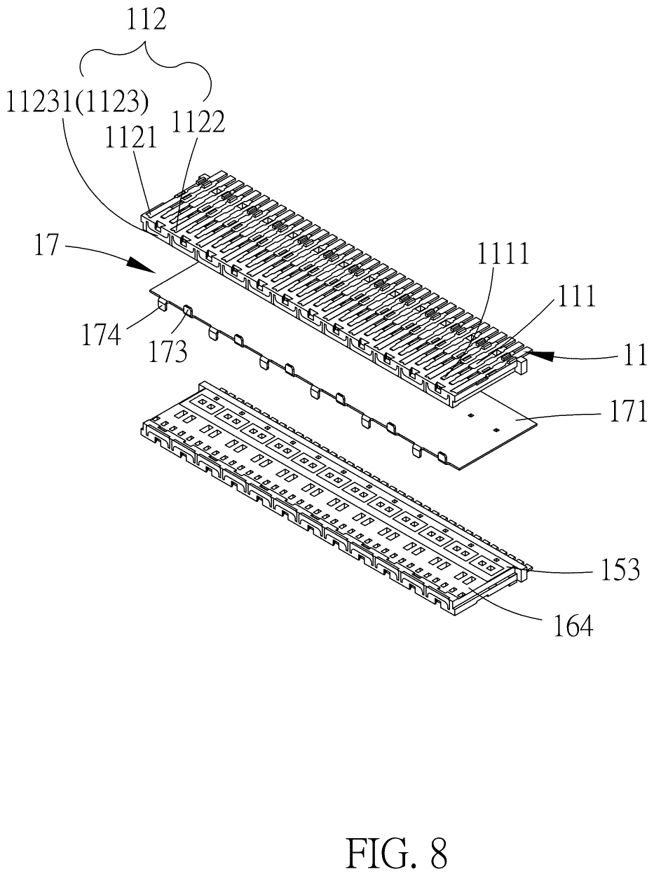

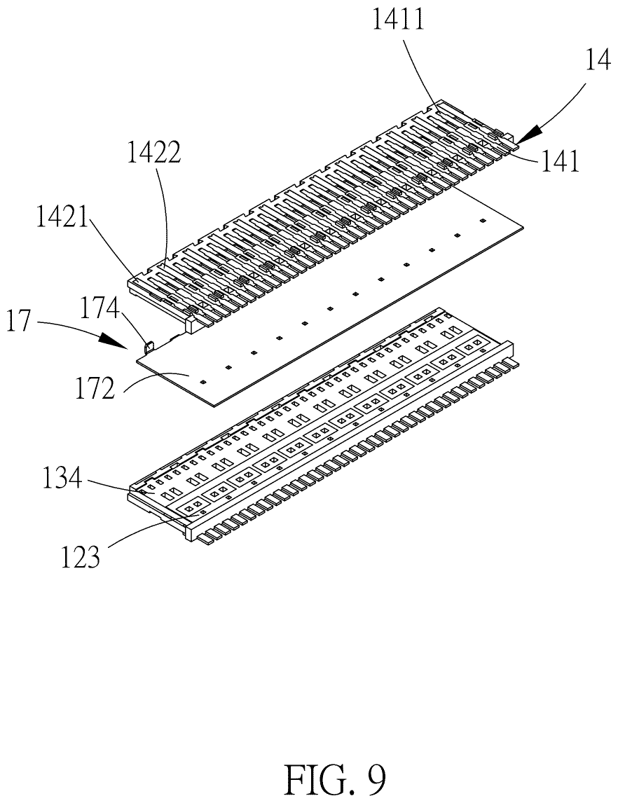

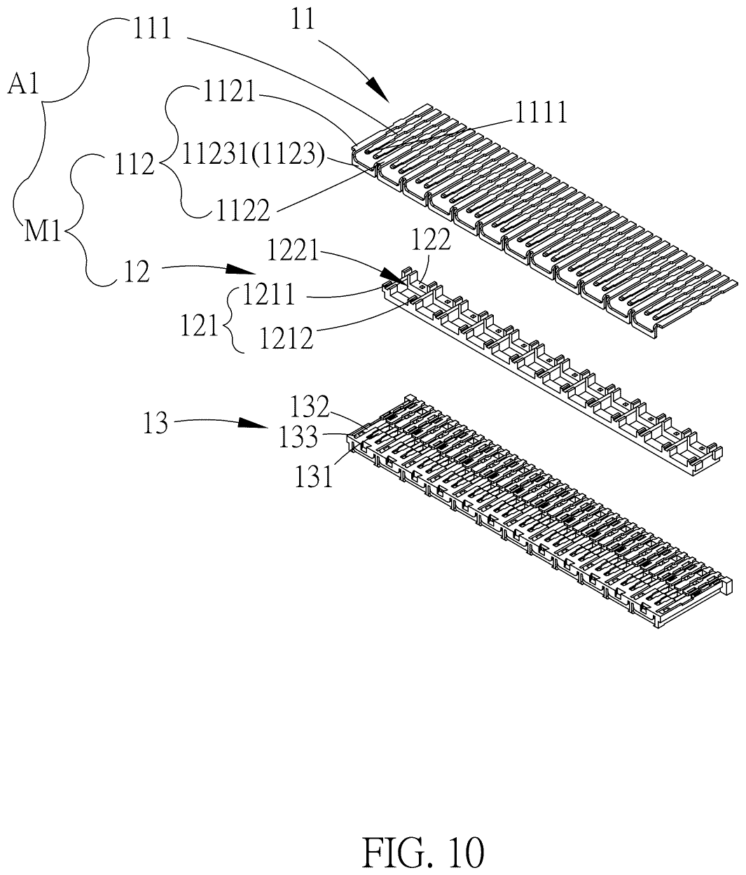

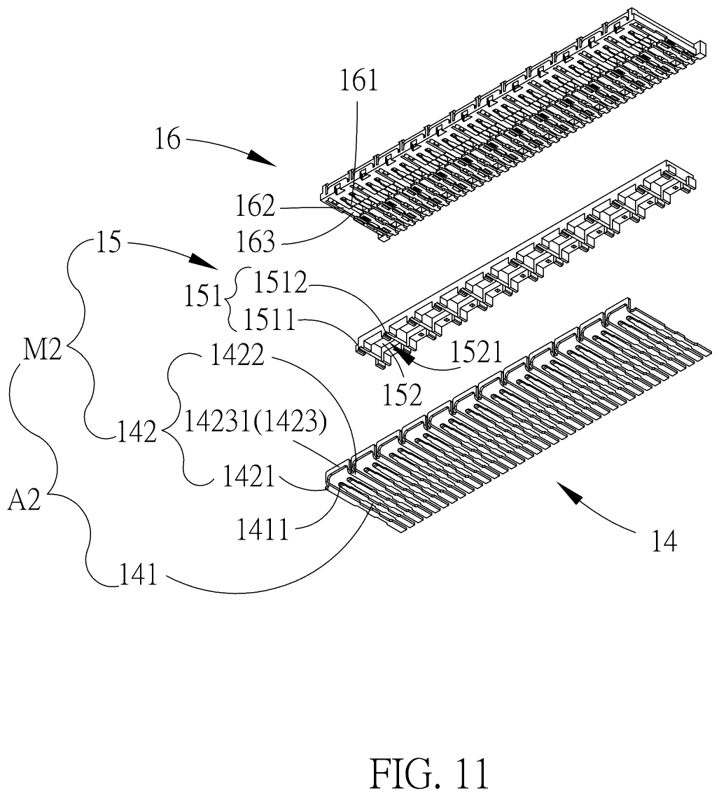

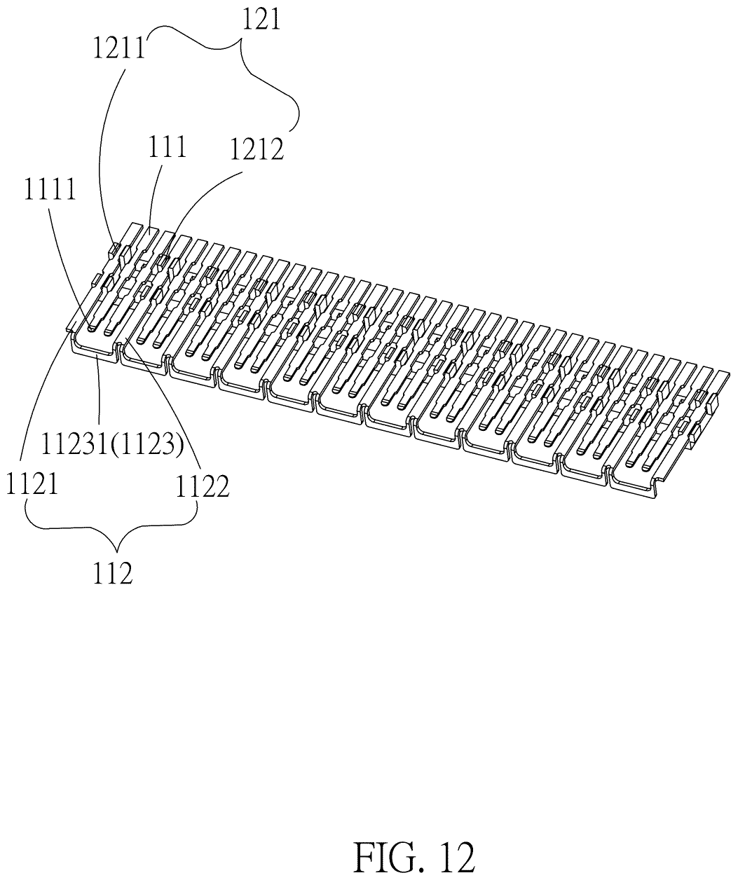

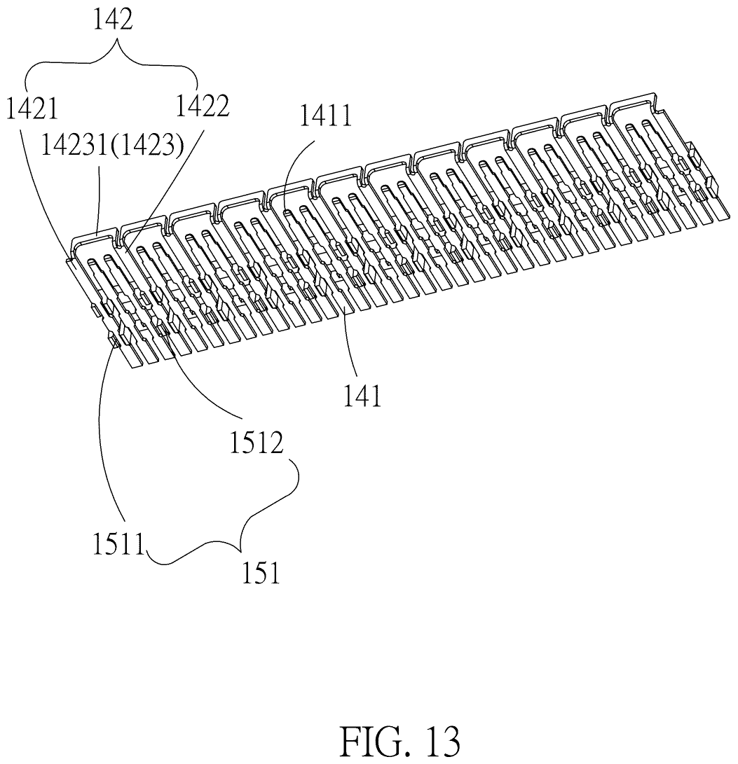

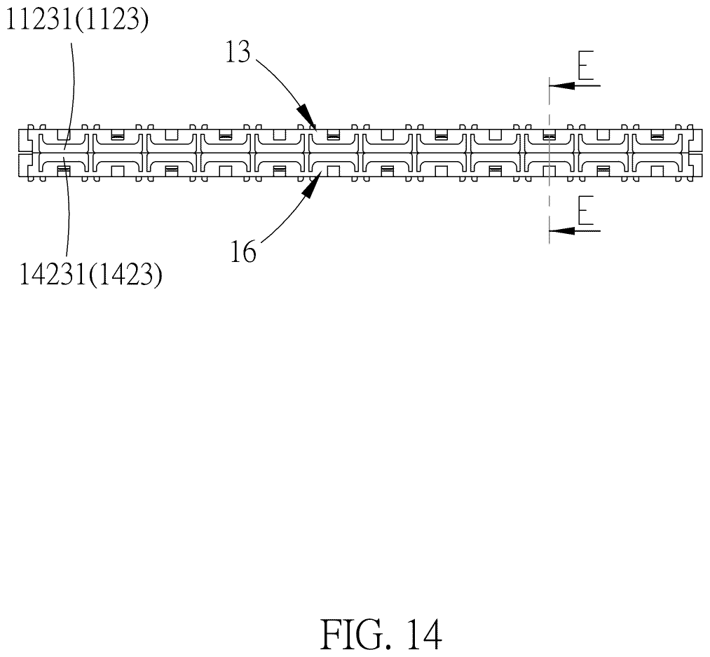

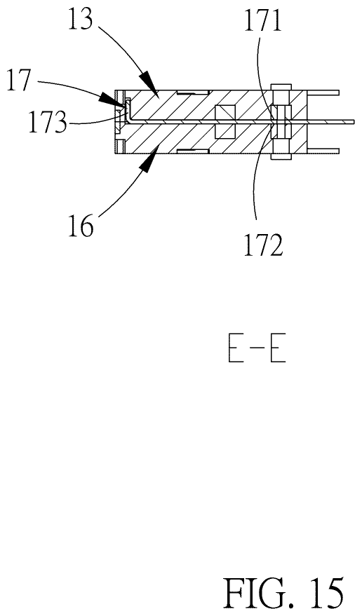

For a detailed description of the embodiments disclosed in the present application, please refer to FIGS. 1 to 15.

In the above embodiment, an electrical connector 1 is provided that is configured to be disposed in an electronic device. In the electronic device, the electrical connector 1 may be used for signal transmission. Additionally, the two sides of the electrical connector 1 may respectively be defined as an electrical connector major side L1 and an electrical connector minor side L2.

In the embodiment shown in FIGS. 1 to 15, the electrical connector 1 comprises: a major conductive terminal set 11, a major conductive plastic base 12, a major insulating core base 13, a minor conductive terminal set 14, a minor conductive plastic base 15, and a minor insulating core base 16.

Regarding the major conductive terminal set 11, the major conductive terminal set 11 comprises a major non-grounding conductive terminal 111 and a major grounding conductive terminal 112. It should be noted that the major non-grounding conductive terminal 111 may transmit non-grounding signals, such as differential signals. The number of the major non-grounding conductive terminals 111 is not limited to one (that is, the number of the major non-grounding conductive terminal 111 is optionally configured to be plural), and the major non-grounding conductive terminal 111 comprises a major non-grounding terminal pin 1111. The major grounding conductive terminal 112 may transmit grounding signals, and the number of the major grounding conductive terminals 112 is likewise not limited to one (that is, the number of the major grounding conductive terminals 112 is optionally configured to be plural), and the major grounding conductive terminal 112 comprises a first major grounding terminal pin 1121, a second major grounding terminal pin 1122, and a major grounding terminal pin bridging structure 1123. Additionally, it should be noted that the quantities of the first major grounding terminal pin 1121, the second major grounding terminal pin 1122, or the major grounding terminal pin bridging structure 1123 are not limited to one (that is, the number of the first major grounding terminal pin 1121, the second major grounding terminal pin 1122, or the major grounding terminal pin bridging structure 1123 are optionally configured to be plural).

In the above embodiment, the major grounding terminal pin bridging structure 1123 electrically bridges the first major grounding terminal pin 1121 and the second major grounding terminal pin 1122 while dividing the major non-grounding terminal pin 1111, such that the major grounding terminal pin bridging structure 1123 is not electrically connected to the major non-grounding terminal pin 1111. This allows the major grounding terminal pin bridging structure 1123, the first major grounding terminal pin 1121, and the second major grounding terminal pin 1122 to be electrically connected and form a major grounding circuit, which transmits shielding signals, such as grounding signals, via the major grounding circuit.

The major conductive plastic base 12 comprises a major conductive plastic base grounding terminal mating structure 121 and a major conductive plastic base non-grounding terminal divider structure 122. The major conductive plastic base grounding terminal mating structure 121 comprises a first major conductive plastic base grounding pin mating substructure 1211 and a second major conductive plastic base grounding pin mating substructure 1212. In the above embodiment, the first major conductive plastic base grounding pin mating substructure 1211 and the second major conductive plastic base grounding pin mating substructure 1212 respectively mate with the first major grounding terminal pin 1121 and the second major grounding terminal pin 1122. Accordingly, the major conductive plastic base grounding terminal mating structure 121 mates with the major grounding conductive terminal 112, thereby electrically connecting the major conductive plastic base 12 with the major grounding conductive terminal 112 to form a major grounding conductive terminal module M1. The major conductive plastic base non-grounding terminal divider structure 122 comprises a major divider structure separating space 1221, which separates the major conductive plastic base 12 from the major non-grounding conductive terminal 111, thereby dividing the major conductive plastic base 12 from the major non-grounding conductive terminal 111 such that the major non-grounding conductive terminal 111 and the major grounding conductive terminal module Ml are not electrically connected. It should be noted that the major grounding conductive terminal module Ml provides a major grounding circuit for transmitting shielding signals, such as grounding signals.

Optionally, the first major conductive plastic base grounding pin mating substructure 1211 and the second major conductive plastic base grounding pin mating substructure 1212 are configured as clamping arm mating structures that respectively clamp the first major grounding terminal pin 1121 and the second major grounding terminal pin 1122.

The major insulating core base 13, made of insulating material, comprises a major insulating core base non-grounding terminal mating structure 131, a major insulating core base grounding terminal module mating structure 132, and a major insulating core terminal pin support structure 133. In the above embodiment, the major insulating core base non-grounding terminal mating structure 131 mates and positions the major non-grounding conductive terminal 111, and the major insulating core base grounding terminal module mating structure 132 mates and positions the major grounding conductive terminal module M1. This arrangement allows the major insulating core base 13, the major non-grounding conductive terminal 111, and the major grounding conductive terminal module M1 to form a major electrical connector subcomponent A1.

It should be noted that, in the electrical connector 1, the major electrical connector subcomponent Al is located on the electrical connector major side L1. Additionally, within the major electrical connector subcomponent A1, the major non-grounding terminal pin 1111, the first major grounding terminal pin 1121, and the second major grounding terminal pin 1122 respectively abut the major insulating core terminal pin support structure 133, enabling the major insulating core terminal pin support structure 133 to provide structural support to the major non-grounding terminal pin 1111, the first major grounding terminal pin 1121, and the second major grounding terminal pin 1122, thereby maintaining their form.

Further, within the major electrical connector subcomponent A1, the first major grounding terminal pin 1121 and the second major grounding terminal pin 1122 are positioned on opposite sides of the major non-grounding terminal pin 1111. In other words, the major non-grounding terminal pin 1111 is located between the first major grounding terminal pin 1121 and the second major grounding terminal pin 1122, allowing the first major grounding terminal pin and the second major grounding terminal pin 1121 and 1122 to transmit shielding signals, such as grounding signals, on both sides of the major non-grounding terminal pin 1111. This provides an electrically shielded environment for signal transmission through the major non-grounding terminal pin 1111, thereby reducing interference during high-speed signal transmission and enhancing the high-speed signal transmission quality of the electrical connector 1 to meet the specific requirements and development of electronic devices.

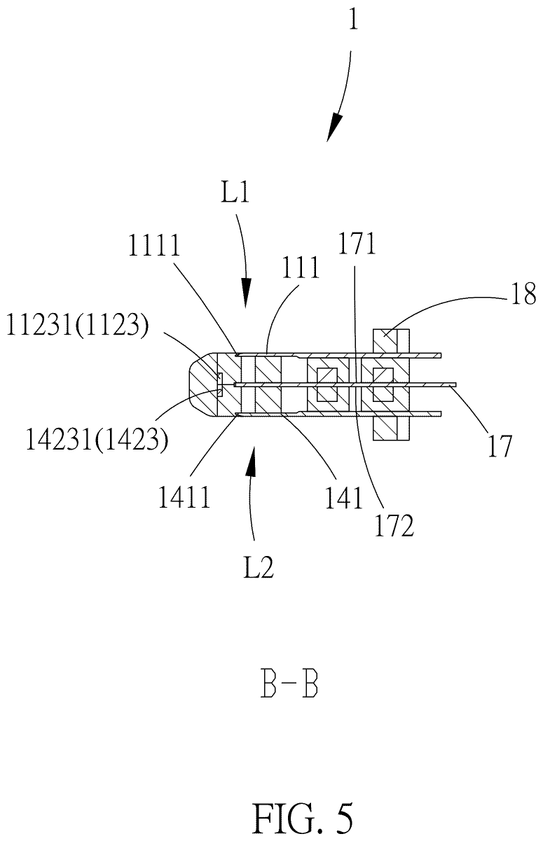

Optionally, in the embodiments shown in FIGS. 5, 8, 10, 12, and 14, the major grounding terminal pin bridging structure 1123 comprises a major grounding terminal pin bridging shielding structure 11231. The major grounding terminal pin bridging shielding structure 11231 extends in front of the major non-grounding terminal pin 1111, thereby providing shielding in front of the major non-grounding terminal pin 1111 for transmitting shielding signals, such as grounding signals. This arrangement creates an electrically shielded environment for the signal transmission of the major non-grounding terminal pin 1111, effectively reducing interference during high-speed signal transmission and improving the high-speed signal transmission quality of the electrical connector 1 to meet the specific requirements and development of electronic devices.

The minor conductive terminal set 14 comprises a minor non-grounding conductive terminal 141 and a minor grounding conductive terminal 142. It should be noted that the minor non-grounding conductive terminal 141 may transmit non-grounding signals, such as differential signals. The number of the minor non-grounding conductive terminals 141 is not limited to one (that is, the number of the minor non-grounding conductive terminal 141 is optionally configured to be plural), and the minor non-grounding conductive terminal 141 comprises a minor non-grounding terminal pin 1411. The minor grounding conductive terminal 142 may transmit grounding signals, and the number of the minor grounding conductive terminals 142 is likewise not limited to one (that is, the number of the minor grounding conductive terminals 142 is optionally configured to be plural), and the minor grounding conductive terminal 142 comprises a first minor grounding terminal pin 1421, a second minor grounding terminal pin 1422, and a minor grounding terminal pin bridging structure 1423. Additionally, the quantities of the first minor grounding terminal pin 1421, the second minor grounding terminal pin 1422, or the minor grounding terminal pin bridging structure 1423 are not limited to one (that is, the number of the first minor grounding terminal pin 1421, the second minor grounding terminal pin 1422, or the minor grounding terminal pin bridging structure 1423 are optionally configured to be plural).

In the above embodiment, the minor grounding terminal pin bridging structure 1423 electrically bridges the first minor grounding terminal pin 1421 and the second minor grounding terminal pin 1422 while dividing the minor non-grounding terminal pin 1411, such that the minor grounding terminal pin bridging structure 1423 is not electrically connected to the minor non-grounding terminal pin 1411. This configuration allows the minor grounding terminal pin bridging structure 1423, the first minor grounding terminal pin 1421, and the second minor grounding terminal pin 1422 to be electrically connected and form a minor grounding circuit, which transmits shielding signals, such as grounding signals, via the minor grounding circuit.

The minor conductive plastic base 15 comprises a minor conductive plastic base grounding terminal mating structure 151 and a minor conductive plastic base non-grounding terminal divider structure 152. The minor conductive plastic base grounding terminal mating structure 151 comprises a first minor conductive plastic base grounding pin mating substructure 1511 and a second minor conductive plastic base grounding pin mating substructure 1512. In the above embodiment, the first minor conductive plastic base grounding pin mating substructure 1511 and the second minor conductive plastic base grounding pin mating substructure 1512 respectively mate with the first minor grounding terminal pin 1421 and the second minor grounding terminal pin 1422. Accordingly, the minor conductive plastic base grounding terminal mating structure 151 mates with the minor grounding conductive terminal 142, thereby electrically connecting the minor conductive plastic base 15 with the minor grounding conductive terminal 142 to form a minor grounding conductive terminal module M2. The minor conductive plastic base non-grounding terminal divider structure 152 comprises a minor divider structure separating space 1521, which separates the minor conductive plastic base 15 from the minor non-grounding conductive terminal 141, thereby dividing the minor conductive plastic base 15 from the minor non-grounding conductive terminal 141 such that the minor non-grounding conductive terminal 141 and the minor grounding conductive terminal module M2 are not electrically connected. It should be noted that the minor grounding conductive terminal module M2 provides a minor grounding circuit for transmitting shielding signals, such as grounding signals.

Optionally, the first minor conductive plastic base grounding pin mating substructure 1511 and the second minor conductive plastic base grounding pin mating substructure 1512 are configured as clamping arm mating structures that respectively clamp the first minor grounding terminal pin 1421 and the second minor grounding terminal pin 1422.

The minor insulating core base 16, made of insulating material, comprises a minor insulating core base non-grounding terminal mating structure 161, a minor insulating core base grounding terminal module mating structure 162, and a minor insulating core terminal pin support structure 163. In the above embodiment, the minor insulating core base non-grounding terminal mating structure 161 mates and positions the minor non-grounding conductive terminal 141, and the minor insulating core base grounding terminal module mating structure 162 mates and positions the minor grounding conductive terminal module M2. This arrangement allows the minor insulating core base 16, the minor non-grounding conductive terminal 141, and the minor grounding conductive terminal module M2 to form a minor electrical connector subcomponent A2.

It should be noted that, in the electrical connector 1, the minor electrical connector subcomponent A2 is located on the electrical connector minor side L2. Additionally, within the minor electrical connector subcomponent A2, the minor non-grounding terminal pin 1411, the first minor grounding terminal pin 1421, and the second minor grounding terminal pin 1422 respectively abut the minor insulating core terminal pin support structure 163, enabling the minor insulating core terminal pin support structure 163 to provide structural support to the minor non-grounding terminal pin 1411, the first minor grounding terminal pin 1421, and the second minor grounding terminal pin 1422, thereby maintaining their form.

Further, within the minor electrical connector subcomponent A2, the first minor grounding terminal pin 1421 and the second minor grounding terminal pin 1422 are positioned on opposite sides of the minor non-grounding terminal pin 1411. In other words, the minor non-grounding terminal pin 1411 is located between the first minor grounding terminal pin 1421 and the second minor grounding terminal pin 1422, allowing the first minor grounding terminal pin and the second minor grounding terminal pin 1421 and 1422 to transmit shielding signals, such as grounding signals, on both sides of the minor non-grounding terminal pin 1411. This provides an electrically shielded environment for signal transmission through the minor non-grounding terminal pin 1411, thereby reducing interference during high-speed signal transmission and enhancing the high-speed signal transmission quality of the electrical connector 1 to meet the specific requirements and development of electronic devices.

Optionally, in the embodiments shown in FIGS. 5, 11, and 13, the minor grounding terminal pin bridging structure 1423 comprises a minor grounding terminal pin bridging shielding structure 14231. The minor grounding terminal pin bridging shielding structure 14231 extends in front of the minor non-grounding terminal pin 1411, thereby providing shielding in front of the minor non-grounding terminal pin 1411 for transmitting shielding signals, such as grounding signals. This arrangement creates an electrically shielded environment for the signal transmission of the minor non-grounding terminal pin 1411, effectively reducing interference during high-speed signal transmission and improving the high-speed signal transmission quality of the electrical connector 1.

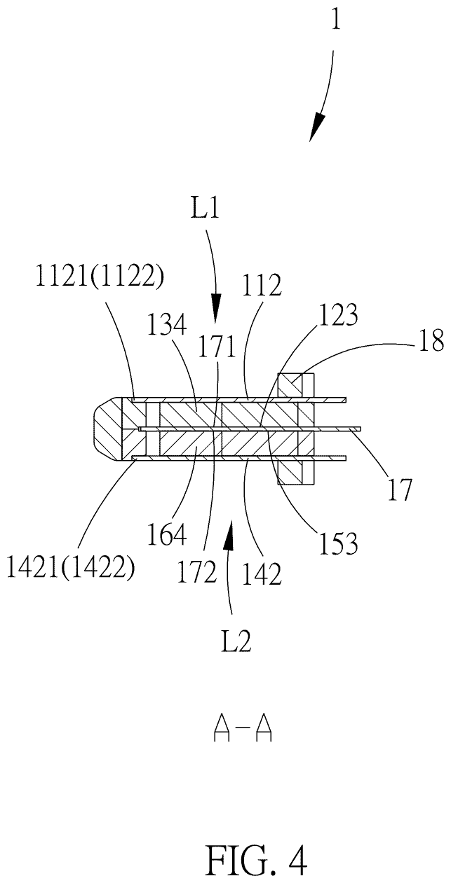

Further, in the embodiments shown in FIGS. 4 to 9 and FIG. 15, the electrical connector 1 further comprises a conductive metal layer 17. The conductive metal layer 17 comprises, for example, a inserting type major conductive metal layer mating structure 173 and a minor conductive metal layer mating structure 174. The major conductive metal layer mating structure 173 is configured to mate with the major insulating core base 13, and the minor conductive metal layer mating structure 174 is configured to mate with the minor insulating core base 16. This allows the major insulating core base 13 and the minor insulating core base 16 to position the conductive metal layer 17 between the major electrical connector subcomponent A1 and the minor electrical connector subcomponent A2, providing an electrically shielded environment for signal transmission between the major non-grounding conductive terminal 111 and the minor non-grounding conductive terminal 141, thereby reducing interference and enhancing high-speed signal transmission quality.

Additionally, the conductive metal layer 17 further comprises a major conductive metal layer connecting structure 171 and a minor conductive metal layer connecting structure 172. Correspondingly, the major conductive plastic base 12 further comprises a major conductive plastic base connecting structure 123, and the minor conductive plastic base 15 further comprises a minor conductive plastic base connecting structure 153. The major insulating core base 13 further comprises a major insulating core base exposure structure 134, and the minor insulating core base 16 further comprises a minor insulating core base exposure structure 164. In the above embodiment, the major insulating core base exposure structure 134 and the minor insulating core base exposure structure 164 expose the major conductive plastic base connecting structures 123 and the minor conductive plastic base connecting structure 153, such that the major conductive plastic base connecting structure 123 electrically connects to the major conductive metal layer connecting structure 171, and the minor conductive plastic base connecting structure 153 electrically connects to the minor conductive metal layer connecting structure 172. Accordingly, the major conductive plastic base 12, the minor conductive plastic base 15, and the conductive metal layer 17 are electrically connected to provide shielding between the major non-grounding terminal pin 1111 and the minor non-grounding terminal pin 1411.

Optionally, the major conductive plastic base connecting structure 123 and the major conductive metal layer connecting structure 171 are configured as mating protrusion and recess structures, and the minor conductive plastic base connecting structure 153 and the minor conductive metal layer connecting structure 172 are also configured as mating protrusion and recess structures.

Further, in the embodiments shown in FIGS. 1 to 7, the electrical connector 1 further comprises an insulating assembled core 18. The insulating assembled core 18, made of insulating material, can assemble the major electrical connector subcomponent A1 and the minor electrical connector subcomponent A2 to respectively position the major electrical connector subcomponent A1 and the minor electrical connector subcomponent A2, enabling the major electrical connector subcomponent A1 and the minor electrical connector subcomponent A2 and to be assembled into an electrical connector assembly A0.

It should be noted that, in the embodiments of the present application, certain components mentioned above may be omitted. For example, the electrical connector may optionally comprise only the major conductive terminal set, the major conductive plastic base, and the major insulating core base. The major conductive terminal set comprises a major non-grounding conductive terminal and a major grounding conductive terminal. The major non-grounding conductive terminal comprises a major non-grounding terminal pin, and the major grounding conductive terminal comprises a first major grounding terminal pin, a second major grounding terminal pin, and a major grounding terminal pin bridging structure. The major grounding terminal pin bridging structure bridges the first major grounding terminal pin and the second major grounding terminal pin while dividing the major non-grounding terminal pin. The major conductive plastic base comprises a major conductive plastic base grounding terminal mating structure and a major conductive plastic base non-grounding terminal divider structure. The major conductive plastic base grounding terminal mating structure mates with the major grounding conductive terminal to form a major grounding conductive terminal module, and the major conductive plastic base non-grounding terminal divider structure divides the major conductive plastic base from the major non-grounding conductive terminal so that there is no electrical connection between the major non-grounding conductive terminal and the major grounding conductive terminal module. The major insulating core base comprises a major insulating core base non-grounding terminal mating structure and a major insulating core base grounding terminal module mating structure. The non-grounding terminal mating structure mates with the major non-grounding conductive terminal, and the grounding terminal module mating structure mates with the major grounding conductive terminal module, allowing the major insulating core base, the major non-grounding conductive terminal, and the major grounding conductive terminal module to form a major electrical connector subcomponent. In this subcomponent, the first major grounding terminal pin and the second major grounding terminal pin are located on both sides of the major non-grounding terminal pin, providing shielding on both sides of the signal path.

In summary, the electrical connector of the present application comprises a non-grounding conductive terminal, a grounding conductive terminal, a conductive plastic base, and an insulating core base. The conductive plastic base is electrically connected to the grounding conductive terminal to transmit shielding signals, such as grounding signals. The grounding conductive terminal comprises a first grounding terminal pin, a second grounding terminal pin, and a grounding terminal pin bridging structure. The bridging structure crosses the non-grounding terminal pin and electrically connects the first grounding terminal pin and the second grounding terminal pin. The insulating core base positions the first grounding terminal pin and the second grounding terminal pin on opposite sides of the non-grounding terminal pin, allowing the first grounding terminal pin and the second grounding terminal pin to provide an electrically shielded environment for signal transmission. In this way, the electrical connector effectively reduces interference during high-speed signal transmission and improves transmission quality to meet the evolving needs of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, one side of which is an electrical connector major side, wherein the electrical connector comprises:
a major conductive terminal set comprising a major non-grounding conductive terminal and a major grounding conductive terminal, wherein the major non-grounding conductive terminal comprises a major non-grounding terminal pin, and the major grounding conductive terminal comprises a first major grounding terminal pin, a second major grounding terminal pin and a major grounding terminal pin bridging structure, wherein the major grounding terminal pin bridging structure is configured to be a bridge over the major non-grounding terminal pin to connect the first major grounding terminal pin and the second major grounding terminal pin, such that the major grounding terminal pin bridging structure, the first major grounding terminal pin, and the second major grounding terminal pin are electrically connected;
a major conductive plastic base comprising a major conductive plastic base grounding terminal mating structure and a major conductive plastic base non-grounding terminal divider structure, wherein the major conductive plastic base grounding terminal mating structure is mated with the major grounding conductive terminal such that the major conductive plastic base and the major grounding conductive terminal are electrically connected to each other to form a major grounding conductive terminal module, and the major conductive plastic base non-grounding terminal divider structure is configured to divide the major conductive plastic base from the major non-grounding conductive terminal so as to prevent electrical connection between the major non-grounding conductive terminal and the major grounding conductive terminal module; and
a major insulating core base comprising a major insulating core base non-grounding terminal mating structure and a major insulating core base grounding terminal module mating structure, wherein the major insulating core base non-grounding terminal mating structure is mated with the major non-grounding conductive terminal, and the major insulating core base grounding terminal module mating structure is mated with the major grounding conductive terminal module, so as to allow the major insulating core base, the major non-grounding conductive terminal and the major grounding conductive terminal module to form a major electrical connector subcomponent located on the electrical connector major side, wherein, in the major electrical connector subcomponent, the first major grounding terminal pin and the second major grounding terminal pin are disposed on opposite sides of the major non-grounding terminal pin to provide shielding for the major non-grounding terminal pin.

2. The electrical connector of claim 1, wherein the major insulating core base further comprises a major insulating core terminal pin support structure, wherein the major non-grounding terminal pin, the first major grounding terminal pin and the second major grounding terminal pin are respectively abutted against the major insulating core terminal pin support structure, such that the major insulating core terminal pin support structure provides structural support for the major non-grounding terminal pin, the first major grounding terminal pin and the second major grounding terminal pin.

3. The electrical connector of claim 1, wherein the major grounding terminal pin bridging structure comprises a major grounding terminal pin bridging shielding structure, and the major grounding terminal pin bridging shielding structure is extended beyond the major non-grounding terminal pin to provide shielding for the major non-grounding terminal pin.

4. The electrical connector of claim 1, wherein the major conductive plastic base grounding terminal mating structure comprises a first major conductive plastic base grounding pin mating substructure and a second major conductive plastic base grounding pin mating substructure, and the first major conductive plastic base grounding pin mating substructure and the second major conductive plastic base grounding pin mating substructure are respectively mated with the first major grounding terminal pin and the second major grounding terminal pin.

5. The electrical connector of claim 4, wherein the first major conductive plastic base grounding pin mating substructure and the second major conductive plastic base grounding pin mating substructure are clamp arm mating structures configured to respectively clamp the first major grounding terminal pin and the second major grounding terminal pin.

6. The electrical connector of claim 1, wherein the major conductive plastic base non-grounding terminal divider structure comprises a major divider structure separating space, and the major divider structure separating space is configured to separate the major conductive plastic base from the major non-grounding conductive terminal.

7. The electrical connector of claim 1, wherein another side of the electrical connector is an electrical connector minor side, and the electrical connector further comprises:
a minor conductive terminal set comprising a minor non-grounding conductive terminal and a minor grounding conductive terminal, wherein the minor non-grounding conductive terminal comprises a minor non-grounding terminal pin, and the minor grounding conductive terminal comprises a first minor grounding terminal pin, a second minor grounding terminal pin and a minor grounding terminal pin bridging structure, wherein the minor grounding terminal pin bridging structure is configured to be a bridge over the minor non-grounding terminal pin to connect the first minor grounding terminal pin and the second minor grounding terminal pin, such that the minor grounding terminal pin bridging structure, the first minor grounding terminal pin and the second minor grounding terminal pin are electrically connected;
a minor conductive plastic base comprising a minor conductive plastic base grounding terminal mating structure and a minor conductive plastic base non-grounding terminal divider structure, wherein the minor conductive plastic base grounding terminal mating structure is mated with the minor grounding conductive terminal such that the minor conductive plastic base and the minor grounding conductive terminal are electrically connected to each other to form a minor grounding conductive terminal module, and the minor conductive plastic base non-grounding terminal divider structure is configured to divide the minor conductive plastic base from the minor non-grounding conductive terminal so as to prevent electrical connection between the minor non-grounding conductive terminal and the minor grounding conductive terminal module; and
a minor insulating core base comprising a minor insulating core base non-grounding terminal mating structure and a minor insulating core base grounding terminal module mating structure, wherein the minor insulating core base non-grounding terminal mating structure is mated with the minor non-grounding conductive terminal, and the minor insulating core base grounding terminal module mating structure is mated with the minor grounding conductive terminal module, so as to allow the minor insulating core base, the minor non-grounding conductive terminal and the minor grounding conductive terminal module to form a minor electrical connector subcomponent located on the electrical connector minor side, wherein, in the minor electrical connector subcomponent, the first minor grounding terminal pin and the second minor grounding terminal pin are disposed on opposite sides of the minor non-grounding terminal pin to provide shielding for the minor non-grounding terminal pin.

8. The electrical connector of claim 7, wherein the minor insulating core base further comprises a minor insulating core terminal pin support structure, wherein the minor non-grounding terminal pin, the first minor grounding terminal pin and the second minor grounding terminal pin are respectively abutted against the minor insulating core terminal pin support structure, such that the minor insulating core terminal pin support structure provides structural support for the minor non-grounding terminal pin, the first minor grounding terminal pin and the second minor grounding terminal pin.

9. The electrical connector of claim 7, wherein the minor grounding terminal pin bridging structure comprises a minor grounding terminal pin bridging shielding structure, and the minor grounding terminal pin bridging shielding structure is extended beyond the minor non-grounding terminal pin to provide shielding for the minor non-grounding terminal pin.

10. The electrical connector of claim 7, wherein the minor grounding terminal pin bridging structure comprises a minor grounding terminal pin bridging shielding structure, the minor grounding terminal pin bridging shielding structure extending in front of the minor non-grounding terminal pin so as to provide shielding in front of the minor non-grounding terminal pin.

11. The electrical connector of claim 7, wherein the minor conductive plastic base grounding terminal mating structure comprises a first minor conductive plastic base grounding pin mating substructure and a second minor conductive plastic base grounding pin mating substructure, wherein the first minor conductive plastic base grounding pin mating substructure is mated with the first minor grounding terminal pin, and the second minor conductive plastic base grounding pin mating substructure is mated with the second minor grounding terminal pin.

12. The electrical connector of claim 11, wherein the first minor conductive plastic base grounding pin mating substructure is clamp arm mating structure configured to clamp the first minor grounding terminal pin, and the second minor conductive plastic base grounding pin mating substructure is clamp arm mating structure configured to clamp the second minor grounding terminal pin.

13. The electrical connector of claim 7, wherein the minor conductive plastic base non-grounding terminal divider structure comprises a minor divider structure separating space, and the minor divider structure separating space is configured to separate the minor conductive plastic base from the minor non-grounding conductive terminal.

14. The electrical connector of claim 7, wherein the major conductive plastic base further comprises a major conductive plastic base connecting structure and a major insulating core base exposure structure, and the minor conductive plastic base further comprises a minor conductive plastic base connecting structure and a minor insulating core base exposure structure, wherein the major insulating core base exposure structure exposes the major conductive plastic base connecting structure, and the minor insulating core base exposure structure exposes the minor conductive plastic base connecting structure, such that the major conductive plastic base connecting structure is connected to the major conductive plastic base connecting structure, and the minor conductive plastic base connecting structure is connected to the minor conductive plastic base connecting structure, so as to electrically connect the major conductive plastic base and the minor conductive plastic base to provide shielding between the major non-grounding terminal pin and the minor non-grounding terminal pin.

15. The electrical connector of claim 7, further comprising a conductive metal layer, the conductive metal layer comprising a major conductive metal layer mating structure and a minor conductive metal layer mating structure, wherein the major conductive metal layer mating structure is mated with the major insulating core base, and the minor conductive metal layer mating structure is mated with the minor insulating core base, such that the conductive metal layer is disposed between the major electrical connector subcomponent and the minor electrical connector subcomponent.

16. The electrical connector of claim 15, wherein the major conductive metal layer mating structure and the minor conductive metal layer mating structure are inserting structures.

17. The electrical connector of claim 15, wherein the conductive metal layer further comprises a major conductive metal layer connecting structure and a minor conductive metal layer connecting structure, the major conductive plastic base further comprises a major conductive plastic base connecting structure, the minor conductive plastic base further comprises a minor conductive plastic base connecting structure, the major insulating core base further comprises a major insulating core base exposure structure, and the minor insulating core base further comprises a minor insulating core base exposure structure, wherein the major insulating core base exposure structure exposes the major conductive plastic base connecting structure, and the minor insulating core base exposure structure exposes the minor conductive plastic base connecting structure, such that the major conductive plastic base connecting structure is connected to the major conductive metal layer connecting structure, and the minor conductive plastic base connecting structure is connected to the minor conductive metal layer connecting structure, so as to electrically connect the major conductive plastic base, the minor conductive plastic base and the conductive metal layer to provide shielding between the major non-grounding terminal pin and the minor non-grounding terminal pin.

18. The electrical connector of claim 17, wherein the major conductive plastic base connecting structure and the major conductive metal layer connecting structure are complementary protrusion and recess structures, and the major conductive plastic base connecting structure and the minor conductive metal layer connecting structure are complementary protrusion and recess structures.

19. The electrical connector of claim 7, further comprising an insulating assembled core configured to be assembled with the major electrical connector subcomponent and the minor electrical connector subcomponent to respectively position the major electrical connector subcomponent and the minor electrical connector subcomponent, so as to allow the major electrical connector subcomponent and the minor electrical connector subcomponent to be assembled to form an electrical connector assembly.
